(19) United States
(12) Patent Application Publication
(10) Pub. No.: US 2008/0238906 A1
(43) Pub. Date: Oct. 2, 2008

(54) DISPLAY DRIVING CIRCUIT AND METHOD FOR CONTROLLING SIGNAL THEREOF

(76) Inventor: Jae-Wook Kwon, Yongin-si (KR)

Correspondence Address: F. CHAU & ASSOCIATES, LLC, 130 WOODBURY ROAD, WOODBURY, NY, 11797, US

(21) Appl. No.: 11/924,048

(22) Filed: Oct. 25, 2007

(30) Foreign Application Priority Data
Mar. 29, 2007 (KR) 10-2007-0031018

(51) Int. Cl. G06F 3/038

(52) U.S. Cl. 345/208

(57) ABSTRACT

A display driving circuit capable of driving a display device with a selected polarity includes a plurality of selection units for selecting any one image data signal from a plurality of input image data signals in response to a first control signal, and a plurality of level converting units, each converting a level of the selected image data signal and outputting an output image data signal having the converted level in response to a second control signal. The second control signal has a level converted in a predetermined time from the point in time when a level of the first control signal is converted. The first control signal may be a polarity selection signal and the second control signal may be a vertical line start signal.

### CROSS-REFERENCE TO RELATED PATENT APPLICATION

This application claims priority under 35 U.S.C. §119 from Korean Patent Application No. 2007-0031018, filed on Mar. 29, 2007, the disclosure of which is hereby incorporated by reference in its entirety.

### BACKGROUND OF THE INVENTION

1. Technical Field

The present disclosure relates to a display driving circuit and a method for driving the same and, more particularly, to a display driving circuit capable of removing current unnecessarily consumed upon level conversion and a method for driving the same.

2. Discussion of Related Art

One of the representative display devices that involve polarity is the Liquid Crystal Display (LCD) device using liquid crystals.

The polarity is classified into a positive level and a negative level on the basis of a reference level. For example, it is assumed that a black color has a voltage difference of ±5V from a reference level. If the reference level is 5V, the voltage of 10V and voltage of 0V have an absolute value of the difference from the reference level of 5V and, thus, ideally, they both display the black color. In terms of properties of the liquid crystal, if the same voltage is continuously supplied to the liquid crystal, the liquid crystal is deteriorated. In order to prevent such deterioration, an LCD device comprising a plurality of liquid crystals uses polarity inversion.

FIG. 1 is a block diagram of a conventional display device. Referring to FIG. 1, a display device (or display), such as an LCD device, comprises a source driver 100 for driving a plurality of data lines Y1, Y2, . . . , Ym-1, and Ym (in which m is a natural number), a gate driver 110 for driving a plurality of gate lines G1 to Gn (in which n is a natural number), a display panel 130 comprising a plurality of pixels 120 connected between the plurality of data lines Y1, Y2, . . . , Ym-1, and Ym and the plurality of gate lines G1 to Gn, and a control unit 150.

When the pixel 120 is used to display digital image data, the gate driver 110 drives a corresponding gate line G1 of the plurality of gate lines G1 to Gn, which are each driven in order, in response to a control signal CON2 output from the control unit 150.

The source driver 100 applies a predetermined voltage to a source line Y1, which is connected to the pixel 120 connected to the driven gate line G1, from the plurality of data lines Y1 to Ym to display the digital image data. In this example, the control unit 150 transmits control signals CON1 to the source driver 100 in addition to digital image data signals DATAm. Representative control signals CON1 include a polarity selection signal, a vertical line start signal (also called “a data latch clock”), a horizontal line start signal, and the like, and the control signals CON1 may vary according to the application or transmission mode of the LCD device.

To interface digital image data to drive a display driving circuit, the Reduced Swing Differential Signaling (RSDS) interface method for transmitting signals with a reduced swing size to reduce current consumed and to improve Electro-magnetic interference (EMI) properties is widely used.

FIG. 2 is a block diagram of the conventional source driver, shown in FIG. 1, using the RSDS data transmission method. Referring to FIG. 2, the source driver 100 comprises a data (or RSDS) receiving unit 210, a serial-parallel converting unit 220, a latch clock generation unit 230, a data storage unit 250, a digital to analog converting (DAC) unit 260 and an output buffer unit 270.

The data receiving unit 210 receives digital image data signals output from a digital image signal transmitting unit (not shown) that are input through data lines D00N/P˜D22N/P, each having a predetermined voltage level, for example, a CMOS voltage level, converts the voltage level of each of the received digital image data signals to a predetermined TTL voltage level and outputs the digital image data signals, each having the predetermined TTL voltage level.

The serial-parallel converting unit 220 synchronizes each of the digital image data signals output from the data receiving unit 210 in response to at least one edge of a rising edge and a falling edge of a clock signal CLK generated by the data receiving unit 210 in response to the input clocks CLKP/CLKN and outputs parallel image data signals.

The latch clock generation unit 230 generates a plurality of shift latch clock signals in order using the clock signal CLK and a horizontal line start signal DIO.

The data storage unit 250 latches each of the parallel image data output from the serial-parallel converting unit 220 in response to each of the plurality of shift latch clock signals, again latches the parallel image data in response to first control signal CTRL1, which is a vertical line start signal CLK1 (or a control signal formed of the vertical line start signal CLK1), and selects the polarity of each of the digital image data signals to be output in response to a first control signal CTRL1, which is a polarity selection signal POL. The data storage unit 250 will be described in detail with reference to FIG. 3A.

The digital to analog converting unit 260 receives the image data signals, each having logic “high” or logic “low”, from the data storage unit 250 and transmits analog signals corresponding to any one of a plurality of gamma voltages (GV) to the output buffer unit 270. For example, when each of the image data signals output from the data storage unit 250 is 6-bits, the total number of gamma voltages GV is 64 (2⁶=64), while each of the image data signals is 8-bits, the total number of the gamma voltages GV is 256 (2⁸=256).

The output buffer unit 270 receives the image data signals output from the digital to analog converting unit 260 and outputs the data signals having a predetermined polarity according to the polarity selection signal POL to a plurality of data lines Y1, Y2, . . . , Ym-1, and Ym. Therefore, each of the plurality of pixels 120 shown in FIG. 1 displays an image in response to each of the data signals.

The polarity selection signal POL is a control signal to select the polarity of the output signal from the output buffer unit 270 to have a positive voltage level or a negative voltage level, based on the reference voltage, for example, the common voltage VCOM of FIG. 1, the vertical line start signal CLK1 is a control signal to display the input image data signals on the display panel 130 in line, and the horizontal line start signal DIO is a ready control signal to receive the image data signals sequentially input to the source driver 100 of FIG. 1.

FIG. 3A is a partial block diagram of the data storage unit 250 of the conventional source driver shown in FIG. 2. FIG. 3A is a partial block diagram of the data storage unit 250 to drive two data lines Y1 and Y2. In this example, it is assumed that the input image data signals DATA1 and DATA2 are each a 6-bit signal.

A first storage unit 310 and a second storage unit 320 store a first input image data signal DATA1 and a second input image data signal DATA2, respectively, in response to a corresponding shift latch clock signal SCLK of a plurality of shift latch clock signals output from the latch clock generation unit 230 of FIG. 2. The first storage unit 310 and the second storage unit 320 may each be a D flip-flop.

A third storage unit 330 receives and stores the data signal stored in the first storage unit 310 in response to a second control signal CTRL2, for example, a vertical line start signal CLK1 or a signal generated using a portion of the vertical line start signal CLK1, and a fourth storage unit 340 receives and stores the data signal stored in the second storage unit 320 in response to the second control signal CTRL2. The third storage unit 330 and the fourth storage unit 340 may each be a D flip-flop.

A first selection unit 350 transmits the image data signal output from the third storage unit 330 or the fourth storage unit 340 to a first level converting unit 370 in response a first control signal CTRL1, for example, a polarity selection signal POL or a signal produced by buffering the polarity selection signal POL, and a second selection unit 360 outputs the image data signal output from the third storage unit 330 or the fourth storage unit 340 to a second level converting unit 380 in response to the first control signal CTRL1. The first selection unit 350 and the second selection unit 360 may each be a multiplexer.

FIG. 3B is a waveform diagram for explaining the problems occurring in the data storage unit 250 shown in FIG. 3A, and the conventional problems are described with reference to FIG. 3B. Generally, the first control signal CTRL1, which is a polarity selection signal POL in FIG. 2 or a signal produced by buffering the polarity selection signal POL, and the second control signal CTRL2, which is a vertical line start signal CLK1 in FIG. 2 or a signal generated by using a portion of the vertical line start signal CLK1, do not accord with each other in respective timepoints of the phase change, for example, A and B.

Also, the level converting units 370 and 380 of FIG. 3A are affected by the first control signal CTRL1 and the second control signal CTRL2. The level converting units 370 and 380 receive the image data signal to be displayed by the second control signal CTRL2. Therefore, in the level converting units 370 and 380, current is unnecessarily consumed at the A timepoint.

Because of this, the display driving circuit performs an unnecessary operation and, consequently, the current consumed by the display driving circuit is increased. Accordingly, it is desired to have an apparatus and a method for reducing unnecessary current consumption upon level conversion while uniformly maintaining an output signal.

### SUMMARY OF THE INVENTION

Exemplary embodiments of the present invention are provided to solve the problems involved in the prior art, as described above and, thus, an exemplary embodiment of the present invention provides a display driving circuit for driving a display device having a polarity comprising a structure capable of eliminating unnecessary current consumption upon level conversion and a method for driving the same.

According to an exemplary embodiment of the present invention, there is provided a method for controlling signals of a display driving circuit comprising selecting any one image data signal from a plurality of input image data signals in response to a first control signal and converting a level of the selected image data signal and outputting an output image data signal having the converted level in response to a second control signal. A level of the second control signal is converted in a predetermined time from the point of time when a level of the first control signal is converted.

The selected image data signal is output as the output image data signal having the converted level in response to the second control signal. The first control signal includes a polarity selection signal for selecting an output polarity of the selected image data signal or a control signal generated on the basis of the polarity selection signal.

The second control signal includes a vertical line start signal or a control signal generated by using the vertical line start signal.

According to an exemplary embodiment of the present invention, there is provided a display driving circuit comprising a selection unit for selecting any one image data signal from a plurality of input image data signals in response to a first control signal; and a level converting unit for converting a level of the selected image data signal and outputting an output image data signal having the converted level in response to a second control signal. A level of the second control signal is converted in a predetermined time from the point of time when a level of the first control signal is converted.

The first control signal includes a polarity selection signal for selecting an output polarity of the selected image data signal or a control signal generated on the basis of the polarity selection signal. The second control signal includes a vertical line start signal or a control signal generated by using the vertical line start signal.

The level converting unit converts a level of the selected image data signal output from the selection unit in a first section of the second control signal, outputs the output image data signal having the converted level, and then, maintains the output image data signal having the converted level during a second section of the second control signal which is successively generated after the first section.

According to an exemplary embodiment of the present invention, there is provided a display driving circuit comprising a plurality of selection units, each selectively outputting a corresponding image data signal from a plurality of input image data signals in response to a first control signal; and a plurality of level converting units, each converting a level of the selected image data signal output from a corresponding selection unit of the plurality of selection units and outputting an output image data signal having the converted level in response to a second control signal. A level of the second control signal is converted in a predetermined time from the point of time when a level of the first control signal is converted.

According to an exemplary embodiment of the present invention, there is provided a display device having a display panel comprising a plurality of data lines, a plurality of gate lines and a plurality of pixels connected between the plurality of data lines and the plurality of gate lines; and a display driving circuit for driving the plurality of data lines in response to a first control signal and a second control signal.

The display driving circuit comprises a plurality of selection units, each selectively outputting a corresponding image data signal from a plurality of input image data signals in response to a first control signal; and a plurality of level converting units, each converting a level of the selected image data signal output from a corresponding selection unit of the plurality of selection units and outputting an output image data signal having the converted level in response to a second control signal. A level of the second control signal is converted in a predetermined time from the point of time when a level of the first control signal is converted. The first control signal includes a polarity selection signal or a control signal generated on the basis of the polarity selection signal and the second control signal includes a vertical line start signal or a control signal generated by using the vertical line start signal.

### BRIEF DESCRIPTION OF THE DRAWINGS

Exemplary embodiments of the present invention will be understood in more detail from the following descriptions taken in conjunction with the attached drawings in which:

FIG. 1 is a block diagram of a conventional display device;

FIG. 2 is a block diagram of the conventional source driver shown in FIG. 1 using the Reduced Swing Differential Signaling (RSDS) interface transmission method;

FIG. 3A is a partial block diagram of the data storage unit of the conventional source driver shown in FIG. 2;

FIG. 3B is a waveform diagram for explaining problems occurring in the data storage unit shown in FIG. 3A;

FIG. 4 is a block diagram for explaining a display driving circuit according to an exemplary embodiment of the present invention;

FIG. 5A is a partial block diagram of a data storage unit of the display driving circuit according to an exemplary embodiment of the present invention;

FIG. 5B is a waveform diagram for explaining the advantages of the structure of the data storage unit of the display driving circuit shown in FIG. 5A; and

FIG. 6 is a circuit diagram of the first level converting unit shown in FIG. 5A.

### DETAILED DESCRIPTION OF EXEMPLARY EMBODIMENTS

Hereinafter, the present invention will be described in detail by explaining exemplary embodiments with reference to the attached drawings. Like reference numerals in the drawings denote like elements.

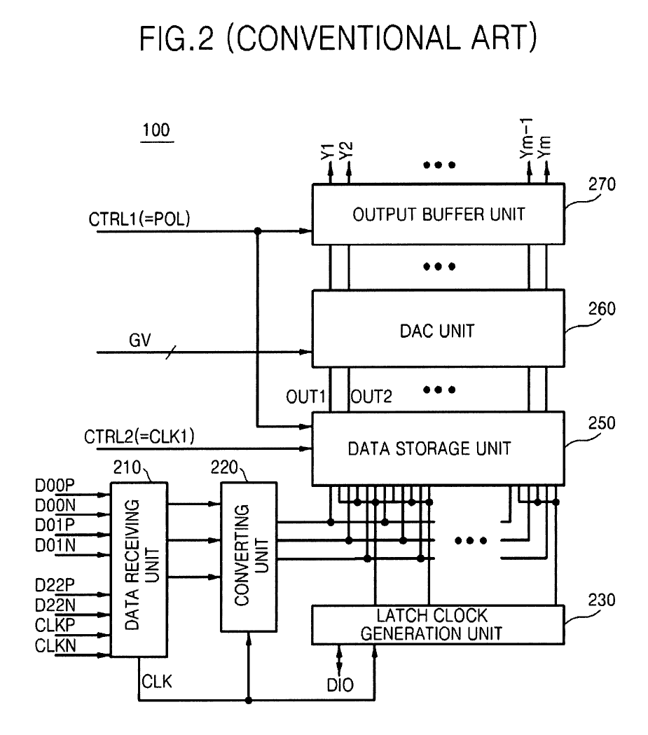

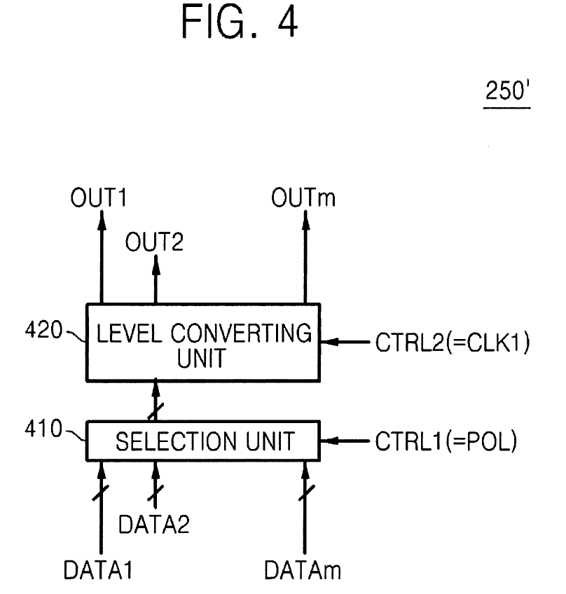

FIG. 4 is a schematic view for explaining a display driving circuit according to an exemplary embodiment of the present invention. Referring to FIG. 4, the display driving circuit, also called “display driver”, “source driver” or “data line driver”, according to an exemplary embodiment of the present invention substantially has the same structure as the source driver 100 shown in FIG. 2, except for the structure of the data storage unit 250′.

The data storage unit 250′ comprises a selection unit 410 for selecting and outputting a corresponding image data signal from a plurality of image data signals DATA1, DATA2 to DATAm input in response to a first control signal CTRL1, and a level converting unit 420 for converting or shifting a level of the image data signal output from the selection unit 410 in response to a second control signal CTRL2. Because the operation of the level converting unit 420 is controlled by the second control signal CTRL2 regardless of the first control signal CTRL1, the level converting unit 420 does not perform unnecessary operations caused by the first control signal CTRL1.

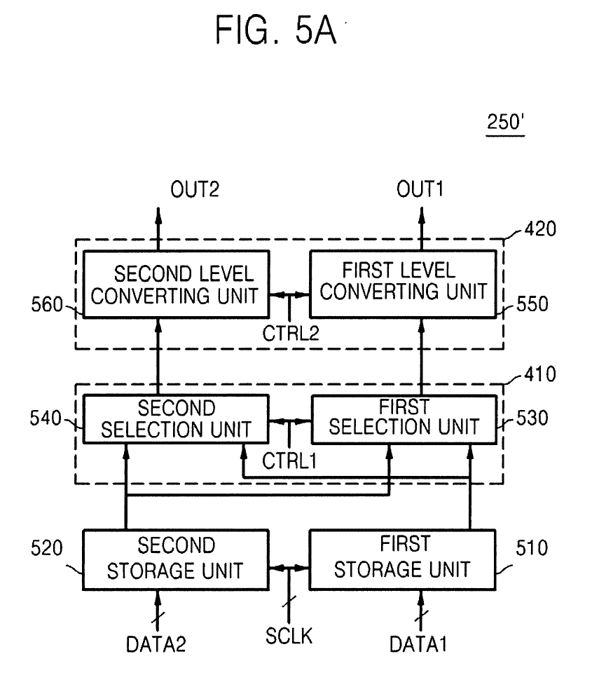

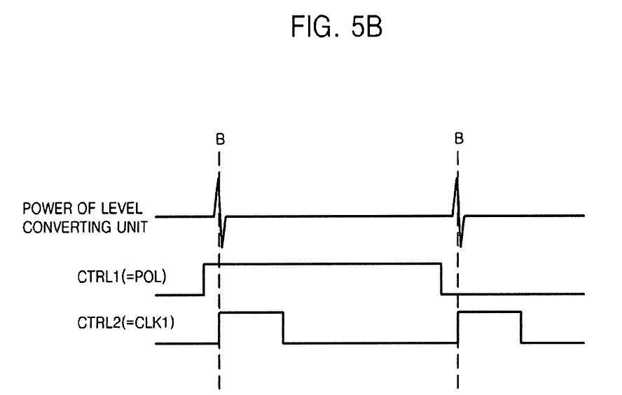

FIG. 5A is a partial block diagram showing the data storage unit of the display driving circuit according to an exemplary embodiment of the present invention. Referring to FIG. 4 and FIG. 5A, the data storage unit 250′ of the display driving circuit comprises a first storage unit 510, a second storage unit 520, a first selection unit 530, a second selection unit 540, a first level converting unit 550 and a second level converting unit 560.

The first storage unit 510 receives and stores a first image data signal DATA1 in response to a corresponding shift latch clock signal SCLK of a plurality of shift latch clock signals, and the second storage unit 520 receives and stores a second image data signal DATA2 in response to a corresponding shift latch clock signal SCLK of the plurality of shift latch clock signals. The first storage unit 510 and the second storage unit 520 may each be a D flip-flop.

The first selection unit 530 and the second selection unit 540 selectively output any one of an output signal of the first storage unit 510 and an output signal of the second storage unit 520 in response to a first control signal CTRL1. The first selection unit 530 and the second selection unit 540 may each be a multiplexer.

The first level converting unit 550 receives an output signal from the first selection unit 530 in response to a second control signal CTRL2 to convert a level of the received signal and outputs a first output signal OUT1 having the converted level.

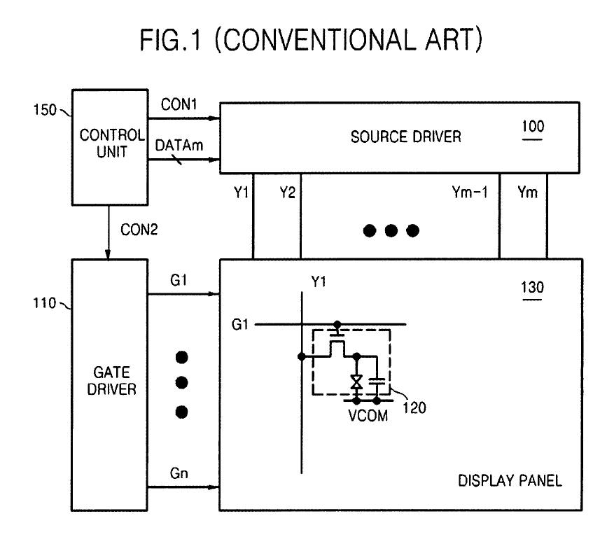

Also, the second level converting unit 560 receives an output signal from the second selection unit 540 in response to the second control signal CTRL2 to convert a level of the received signal and outputs a second output signal OUT2 having the converted level. The first output signal OUT1 may be converted to a signal for driving the data line Y1, as shown in FIG. 1, and the second output signal OUT2 may be converted to a signal for driving the data line Y2, as shown in FIG. 1. For convenience of explanation, in FIG. 5A, only two storage units 510 and 520, a selection unit 410 having only two selection units 530 and 540, and a level converting unit 420 having only two level converting units 550 and 560 are shown.

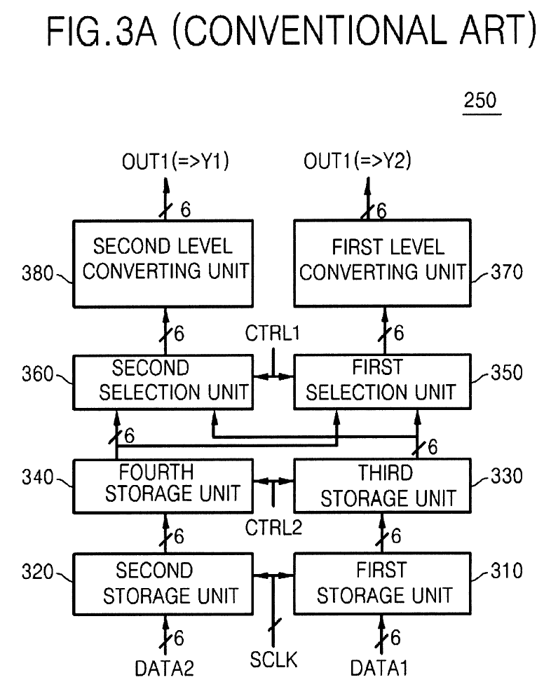

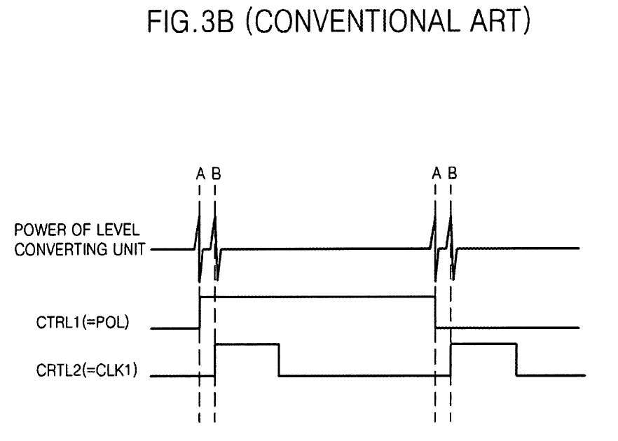

Because the level converting units 550 and 560 according to an exemplary embodiment of the present invention are controlled only by the second control signal CTRL2 regardless of the first control signal CTRL1, unlike the level converting units 370 and 380 of the conventional data storage unit 250 shown in FIG. 3A, the level converting units 550 and 560 advantageously do not perform unnecessary operations caused by the first control signal CTRL1.

FIG. 5B is a waveform diagram for explaining the advantages provided by the structure of the data storage unit of the display driving circuit shown in FIG. 5A. Referring to FIG. 3B and FIG. 5B, it can be seen in FIG. 5B that the current A unnecessarily consumed in the level converting units 550 and 560 is removed by the first control signal CTRL1. This is because the level converting units 550 and 560 receive and maintain image data signals DATA1 and DATA2 only in response to the second control signal CTRL2, and the level converting units 550 and 560 are not affected by the output signals of the selection units 530 and 540 that operate by the phase change of the first control signal CTRL1.

Also, although it is shown in FIG. 5B that the phase of the first control signal CTRL1 is changed prior to the phase change of the second control signal CTRL2, without regard to the order of the phase change of the first control signal CTRL1 and the second control signal CTRL2, the level converting units 550 and 560 are controlled only by the second control signal CTRL2.

The first control signal CTRL1 is a polarity selection signal POL or a signal generated by the polarity selection signal POL and the second control signal CTRL2 is a vertical line start signal CLK1 or a signal generated by the vertical line start signal CLK1.

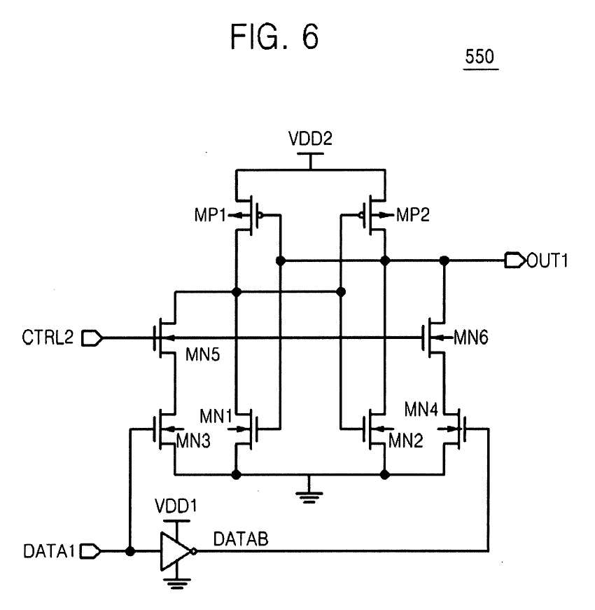

FIG. 6 is a circuit diagram of the first level converting unit 550 shown in FIG. 5A. The first level converting unit 550 may be a latch type level shifter. The structure of the second level converting unit 560 is substantially the same as the structure of the first level converting unit 550.

Referring to FIG. 6, switches MN5 and MN6 that receive a second control signal CTRL2 through a respective gate are connected in the form of cascode onto an input stage to receive a first image data signal DATA1 of the level shifter 550.

When the first input image data signal DATA1 having a first level, for example, a high level, is input, an NMOS transistor MN3 is turned-on, while an NMOS transistor MN4 is turned-off in response to a inverse signal DATAB having a second level, for example, a low level. In this exemplary embodiment, if the second control signal CTRL2 maintains the second level, for example, a low level, an output data signal OUT1 of the output stage does not show any change in the level and the level shifter 550 does not consume any current or power.

When the level of the second control signal CTRL2 is changed to a first level, for example, a high level, the NMOS transistors MN5 and MN6 are turned-on and, thus, an NMOS transistor MN5, a PMOS transistor MP1, and an NMOS transistor MN1 have their drain voltages changed to the second level (low level), and a PMOS transistor MP2 and an NMOS transistor MN2 have a gate voltage of the second level (low level). Accordingly, the PMOS transistor MP2 is turned-on and the NMOS transistor MN2 is turned-off, whereby the level of output data signal OUT1 at the output stage becomes a second voltage VDD2. In this exemplary embodiment, the first level of the second voltage VDD2 is higher than the first level of the first voltage VDD1.

Because the level of the output data signal OUT1, that is, VDD2, is the voltage level at the gates of the PMOS transistor MP1 and the NMOS transistor MN1, the PMOS transistor MP1 is turned-off, the NMOS transistor MN1 is turned-on and the PMOS transistor MP2 is turned-on, whereby the level of the output data signal OUT1 is fixed at the second voltage VDD2 level. If the second control signal CTRL2 has the second level, the NMOS transistors MN5 and MN6 are turned-off, whereby the level of the output data signal OUT1 at the output stage, for example, VDD2, is maintained without regard to the level change of the first input image data signal DATA1.

Therefore, the latch type level shifter 550 receives the first input image data signal DATA1, at the moment the level of the second control signal CTRL2 is shifted to the first level, for example, the high level, and outputs the output data signal OUT1. Also, when the level of the second control signal CTRL2 is changed to the second level, for example, the low level, the level of the output data signal OUT1 is maintained at the level of the output data signal OUT1 corresponding to the level of the received first input image data signal DATA1 without regard to the level change of the first input image data signal DATA1, while the level of the second control signal CTRL2 is maintained at the first level.

The cascode switches MN5 and MN6 may be an NMOS transistor or a PMOS transistor. When the cascode switches MN5 and MN6 are formed of PMOS transistors, the level shifter 550 performs the same operation, except that the second control signal CTRL2 has a reverse phase. Therefore, the detailed explanation for this exemplary embodiment is omitted.

The flat panel display, or display device, according to an exemplary embodiment of the present invention includes a display driving circuit comprising the data storage unit.

The data storage unit or the display driving circuit comprising the data storage unit, as described above, is not affected by an output signal of the selection unit that is changed according to a polarity inversion signal by using a level converting unit directly responding to a control signal. Therefore, it is examined through the example that current unnecessarily consumed upon level conversion in the display driving circuit for driving the display device having a controlled polarity can be removed.

As described above, the display driving circuit according to an exemplary embodiment of the present invention is effective in removing an unnecessary operation section of the level converting unit by directly applying a control signal for level conversion to the level converting unit.

Therefore, in addition to the removal of unnecessarily consumed current, the display driving circuit according to an exemplary embodiment of the present invention is advantageous in terms of its size by simplifying the data storage unit. Also, since the display driving circuit according to an exemplary embodiment of the present invention can remove the unnecessary power consumption in the circuit, it can reduce the EMI generated by the unnecessary current and also reduce the cost, thereby improving competitiveness.

Although exemplary embodiments of the present invention have been shown and described, the present invention is not limited to the described exemplary embodiments. Instead, it will be appreciated by those of ordinary skill in the art that changes may be made to these exemplary embodiments without departing from the principles and spirit of the invention, the scope of which is defined by the claims and their equivalents.

What is claimed is:

1. A method for controlling signals of a display driving circuit comprising:
selecting one image data signal from a plurality of input image data signals in response to a first control signal; and
converting a level of the selected image data signal and outputting an output image data signal having the converted level in response to a second control signal,
wherein a level of the second control signal is converted in a predetermined time from a point in time when a level of the first control signal is converted.

2. The method of claim 1, wherein the selected one image data signal is output as the output image data signal having the converted level synchronized with the second control signal.

3. The method of claim 1, wherein the first control signal includes polarity information to control an output polarity of the selected image data signal.

4. The method of claim 1, wherein the first control signal includes one of a polarity selection signal for selecting an output polarity of the selected one image data signal and a control signal generated based on the polarity selection signal.

5. The method of claim 1, wherein the second control signal includes one of a vertical line start signal and a control signal generated by using the vertical line start signal.

6. A display driving circuit comprising:
a selection unit for selecting an image data signal from a plurality of input image data signals in response to a first control signal; and
a level converting unit for converting a level of the selected image data signal in response to a second control signal and outputting an output image data signal having the converted level,
wherein a level of the second control signal is converted in a predetermined time from a point in time when a level of the first control signal is converted.

7. The display driving circuit of claim 6, wherein the first control signal includes polarity information to control an output polarity of the selected image data signal.

8. The display driving circuit of claim 6, wherein the first control signal includes one of a polarity selection signal for selecting an output polarity of the selected image data signal and a control signal generated on the basis of the polarity selection signal.

9. The display driving circuit of claim 6, wherein the second control signal includes one of a vertical line start signal and a control signal generated based on the vertical line start signal.

10. The display driving circuit of claim 6, wherein the level converting unit converts a level of the selected image data signal output from the selection unit in a first section of the second control signal, outputs the output image data signal having the converted level, and maintains the output image data signal having the converted level during a second section of the second control signal that is successively generated after the first section.

11. A display driving circuit comprising:
a plurality of selection units, each selectively outputting a corresponding image data signal from a plurality of input image data signals in response to a first control signal; and
a plurality of level converting units, each converting a level of the selected image data signal output from a corresponding selection unit of the plurality of selection units and outputting an output image data signal having the converted level in response to a second control signal,
wherein a level of the second control signal is converted in a predetermined time from a point in time when a level of the first control signal is converted.

12. The display driving circuit of claim 11, wherein the first control signal includes one of a polarity selection signal and a control signal generated on the basis of the polarity selection signal.

13. The display driving circuit of claim 11, wherein the second control signal includes one of a vertical line start signal and a control signal generated based on the vertical line start signal.

14. The display driving circuit of claim 11, wherein each of the plurality of level converting units converts a level of the selected image data signal output from a corresponding selection unit of the plurality of selection units in a first section of the second control signal, outputs the output image data signal having the converted level, and then, maintains the output image data signal having the converted level during a second section of the second control signal successively generated after the first section.

15. A display device comprising:
a display panel having a plurality of data lines, a plurality of gate lines, and a plurality of pixels connected between the plurality of data lines and the plurality of gate lines; and
a display driving circuit for driving the plurality of data lines in response to a first control signal and a second control signal,
wherein the display driving circuit comprises:
a plurality of selection units, each selectively outputting a corresponding image data signal from a plurality of input image data signals in response to the first control signal; and
a plurality of level converting units, each converting a level of the selected image data signal output from a corresponding selection unit of the plurality of selection units and outputting an output image data signal having the converted level to a corresponding data line of the plurality of data lines in response to the second control signal,
wherein a level of the second control signal is converted in a predetermined time from a point in time when a level of the first control signal is converted.

16. The display device of claim 15, wherein the first control signal includes one of a polarity selection signal and a control signal generated based on the polarity selection signal and the second control signal includes one of a vertical line start signal and a control signal generated based on the vertical line start signal.
